(19) United States
(12) Patent Application Publication
(10) Pub. No.: US 2002/0144108 A1
(43) Pub. Date: Oct. 3, 2002

(54) Method and system for public-key-based secure authentication to distributed legacy applications

(75) Inventor: Messaoud Benantar, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, Armonk, NY

(21) Appl. No.: 09/821,079

(22) Filed: Mar. 29, 2001

(51) Int. Cl. H04L 9/00

(52) U.S. Cl. 713/156

(57) ABSTRACT

A method, a system, an apparatus, and a computer program product are presented for an authentication process. A host application or system within a distributed data processing system supports one or more controlled resources, such as a legacy application, that requires the receipt of authentication data prior to allowing a user to have access to the controlled resource. The required authentication data is encrypted using the public key of the host system, and an attribute certificate containing the encrypted authentication data is generated by an attribute-certificate-issuing authority. When a user of a client application or system requires access to the controlled resource, the attribute certificate is sent to the host, which decrypts the authentication data with its private key prior to forwarding the authentication data to the controlled resource. The controlled resource then authenticates a user based on the provided authentication data.

### BACKGROUND OF THE INVENTION

1. Field of the Invention

The present invention relates to an improved data processing system and, in particular, to a method and apparatus for multicomputer data transferring. Still more particularly, the present invention provides a method and apparatus for computer-to-computer authentication.

2. Description of Related Art

Commercial use of the Internet has been increasing dramatically. Web-based and Internet-based applications have now become so commonplace that when one learns of a new product or service, one assumes that the product or service will incorporate Internet functionality into the product or service. New applications that incorporate significant proprietary technology are only developed when an enterprise has a significantly compelling reason for doing so. Many corporations have employed proprietary data services for many years, but it is now commonplace to assume that individuals and small enterprises also have access to digital communication services. Many of these services are or will be Internet-based, and the amount of electronic communication on the Internet is growing exponentially.

One of the factors influencing the growth of the Internet is the adherence to open standards for much of the Internet infrastructure. Individuals, public institutions, and commercial enterprises alike are able to introduce new content, products, and services that are quickly integrated into the digital infrastructure because of their ability to exploit common knowledge of open standards.

Concerns about the integrity and privacy of electronic communication have also grown with adoption of Internet-based services. Various encryption and authentication technologies have been developed to protect electronic communication. For example, an open standard promulgated for protecting electronic communication is the X.509 standard for digital certificates.

An X.509 digital certificate is an International Telecommunications Union (ITU) standard that has been adopted by the Internet Engineering Task Force (IETF) body. It cryptographically binds the certificate holder, presumably the subject name within the certificate, with its public cryptographic key. This cryptographic binding is based on the involvement of a trusted entity in the Internet Public Key Infrastructure (PKIX) called the “Certifying Authority”. As a result, a strong and trusted association between the certificate holder and its public key can become public information yet remain tamper-proof and reliable. An important aspect of this reliability is a digital signature that the Certifying Authority stamps on a certificate before it is released for use. Subsequently, whenever the certificate is presented to a system for use of a service, its signature is verified before the subject holder is authenticated. After the authentication process is successfully completed, the certificate holder may be provided access to certain information, services, or controlled resources, i.e. the certificate holder may be authorized to access certain systems.

A standard for an X.509 Attribute Certificate has been proposed by which attribute certificates would be similar in structure to public key certificates but in which the attribute certificate would not contain a public key. An attribute certificate would be used to certify or otherwise securely bind a set of authorization capabilities to its subject holder. Those capabilities are possibly authenticated and then cryptographically verified by a target service sought by the holder of the attribute certificate, and the attribute certificate may then be used for enabling access to controlled resources.

Many legacy systems have been modified to operate with open standard functionality, such as X.509 certificates, so that system services are widely available yet secure. However, although an updated legacy system may be more conveniently accessed through the Internet or through a corporate intranet, there may be justifiable economic or personnel reasons for not modifying certain systems. Hence, many enterprises have legacy systems that are being maintained but not updated with new technologies.

Most legacy systems ensure secure access through the use of a password or other secret or secure information, such as biometric identifiers, that must be simultaneously asserted along with a user's identity. Since an individual may have many identities on different legacy systems, an enterprise's information technology infrastructure may be confusing to the average user and relatively inconvenient to use. The methodology of securing access to legacy systems can present barriers to enterprise-wide goals of enhancing efficiency and workflow compared with newer or updated interconnected systems that employ open standards for authentication.

Therefore, it would be advantageous to have a method and system in which secure user access to a legacy system could be provided through an interconnected system without the necessity of modifying the legacy system. It would be particularly advantageous to use the trusted relationships associated with digital certificates in order to authenticate user access to these legacy systems.

### SUMMARY OF THE INVENTION

A method, a system, an apparatus, and a computer program product are presented for an authentication process. A host application or system within a distributed data processing system supports one or more controlled resources, such as a legacy application, that requires the receipt of authentication data prior to allowing a user to have access to the controlled resource. The required authentication data is encrypted using the public key of the host system, and an attribute certificate containing the encrypted authentication data is generated by an attribute-certificate-issuing authority. When a user of a client application or system requires access to the controlled resource, the attribute certificate is sent to the host, which decrypts the authentication data with its private key prior to forwarding the authentication data to the controlled resource. The controlled resource then authenticates a user based on the provided authentication data.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 depicts a typical manner in which an entity obtains a digital certificate;

FIG. 3A is a block diagram depicting a typical manner in which an entity may use a digital certificate to be authenticated to an Internet system or application;

FIG. 3B is a block diagram depicting a typical manner in which an entity may use authentication data to be authenticated to a legacy system or application;

FIG. 3C is a block diagram depicting a typical manner in which an entity may use authentication data to be authenticated to a legacy system or application through a middleware layer;

FIG. 3D is a block diagram depicting a typical manner in which an entity may use a digital certificate and an accompanying attribute certificate to be authenticated and authorized to an Internet system or application in order to be granted access to controlled resources;

FIG. 4A shows some of the fields of a standard X.509 digital certificate;

FIGS. 4B-4D show some of the fields of an X.509 attribute certificate;

FIG. 5 is a diagram depicting a process for requesting an X.509 attribute certificate containing encrypted authorization attributes and also a process for using the X.509 attribute certificate that will access a target legacy application in accordance with a preferred embodiment of the present invention;

FIG. 6 is a flowchart depicting a process for obtaining an attribute certificate that will authenticate a certificate holder to a target legacy application in accordance with a preferred embodiment of the present invention; and

FIG. 7 is a flowchart depicting a process for using an attribute certificate that will authenticate a certificate holder to a target legacy application in accordance with a preferred embodiment of the present invention.

### DETAILED DESCRIPTION OF THE INVENTION

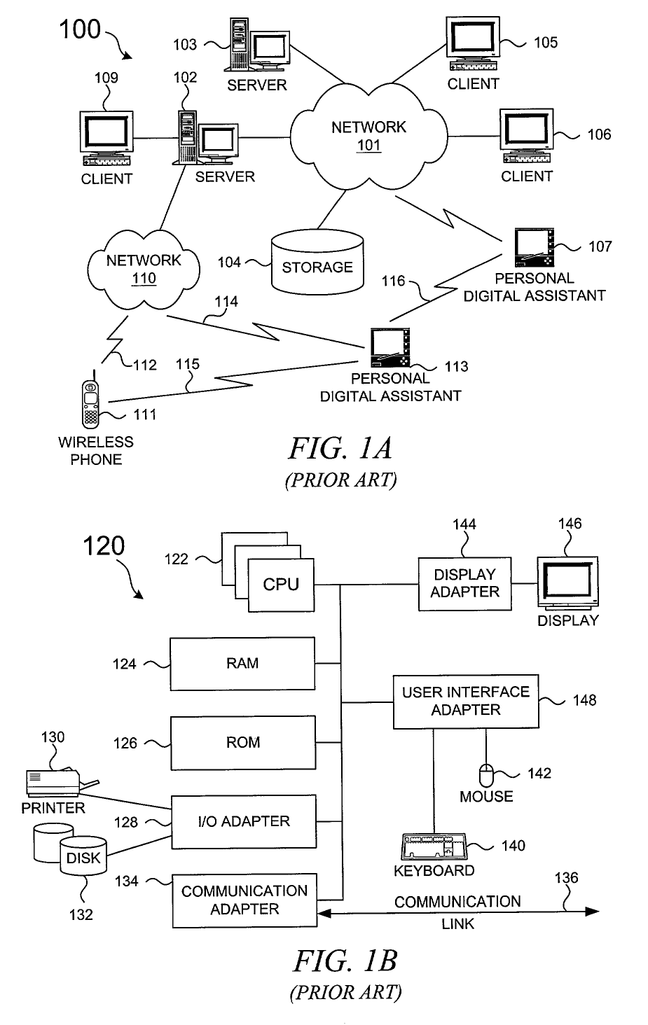

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. In other words, one of ordinary skill in the art would not expect to find similar components or architectures within a Web-enabled or network-enabled phone and a fully featured desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files. Hence, it should be noted that the distributed data processing system shown in FIG. 1A is contemplated as being fully able to support a variety of peer-to-peer subnets and peer-to-peer services.

The present invention may be implemented on a variety of hardware and software platforms, as described above. More specifically, though, the present invention is directed to providing an authorization methodology that secures user access to applications or systems within a distributed data processing environment. To accomplish this goal, the present invention uses the trusted relationships associated with digital certificates in a novel manner to authorize user access for an application or system. Before describing the present invention in more detail, though, some background information about digital certificates is provided for evaluating the operational efficiencies and other advantages of the present invention.

Digital certificates support public key cryptography in which each party involved in a communication or transaction has a pair of keys, called the public key and the private key. Each party's public key is published while the private key is kept secret. Public keys are numbers associated with a particular entity and are intended to be known to everyone who needs to have trusted interactions with that entity. Private keys are numbers that are supposed to be known only to a particular entity, i.e. kept secret. In a typical public key cryptographic system, a private key corresponds to exactly one public key.

Within a public key cryptography system, since all communications involve only public keys and no private key is ever transmitted or shared, confidential messages can be generated using only public information and can be decrypted using only a private key that is in the sole possession of the intended recipient. Furthermore, public key cryptography can be used for authentication, i.e. digital signatures, as well as for privacy, i.e. encryption.

Encryption is the transformation of data into a form unreadable by anyone without a secret decryption key; encryption ensures privacy by keeping the content of the information hidden from anyone for whom it is not intended, even those who can see the encrypted data. Authentication is a process whereby the receiver of a digital message can be confident of the identity of the sender and/or the integrity of the message.

For example, when a sender encrypts a message, the public key of the receiver is used to transform the data within the original message into the contents of the encrypted message. A sender uses a public key to encrypt data, and the receiver uses a private key to decrypt the encrypted message.

When authenticating data, data can be signed by computing a digital signature from the data and the private key of the signer. Once the data is digitally signed, it can be stored with the identity of the signer and the signature that proves that the data originated from the signer. A signer uses a private key to sign data, and a receiver uses the public key to verify the signature. The present invention is directed to a form of authentication using digital certificates; some encryption is also performed during the processing within the present invention.

A certificate is a digital document that vouches for the identity and key ownership of entities, such as an individual, a computer system, a specific server running on that system, etc. Certificates are issued by certificate authorities. A certificate authority (CA) is an entity, usually a trusted third party to a transaction, that is trusted to sign or issue certificates for other people or entities. The CA usually has some kind of legal responsibilities for its vouching of the binding between a public key and its owner that allow one to trust the entity that signed a certificate. There are many such certificate authorities, such as VeriSign, Entrust, etc. These authorities are responsible for verifying the identity and key ownership of an entity when issuing the certificate.

If a certificate authority issues a certificate for an entity, the entity must provide a public key and some information about the entity. A software tool, such as specially equipped Web browsers, may digitally sign this information and send it to the certificate authority. The certificate authority might be a company like VeriSign that provides trusted third-party certificate authority services. The certificate authority will then generate the certificate and return it. The certificate may contain other information, such as dates during which the certificate is valid and a serial number. One part of the value provided by a certificate authority is to serve as a neutral and trusted introduction service, based in part on their verification requirements, which are openly published in their Certification Service Practices (CSP).

Typically, after the CA has received a request for a new digital certificate, which contains the requesting entity's public key, the CA signs the requesting entity's public key with the CA's private key and places the signed public key within the digital certificate. Anyone who receives the digital certificate during a transaction or communication can then use the public key of the CA to verify the signed public key within the certificate. The intention is that an entity's certificate verifies that the entity owns a particular public key.

The X.509 standard is one of many standards that defines the information within a certificate and describes the data format of that information. The “version” field indicates the X.509 version of the certificate format with provision for future versions of the standard. This identifies which version of the X.509 standard applies to this certificate, which affects what information can be specified in it. Thus far, three versions are defined. Version 1 of the X.509 standard for public key certificates was ratified in 1988. The version 2 standard, ratified in 1993, contained only minor enhancements to the version 1 standard. Version 3, defined in 1996, allows for flexible extensions to certificates in which certificates can be extended in a standardized and generic fashion to include additional information.

In addition to the traditional fields in public key certificates, i.e. those defined in versions 1 and 2 of X.509, version 3 comprises extensions referred to as “standard extensions”. The term “standard extensions” refers to the fact that the version 3 of the X.509 standard defines some broadly applicable extensions to the version 2 certificate. However, certificates are not constrained to only the standard extensions, and anyone can register an extension with the appropriate authorities. The extension mechanism itself is completely generic.

Other aspects of certificate processing are also standardized. The Certificate Request Message Format (RFC 2511) specifies a format recommended for use whenever a relying party is requesting a certificate from a CA. Certificate Management Protocols have also been promulgated for transferring certificates. More information about the X.509 public key infrastructure (PKIX) can be obtained from the Internet Engineering Task Force (IETF) at www.ietf.org.

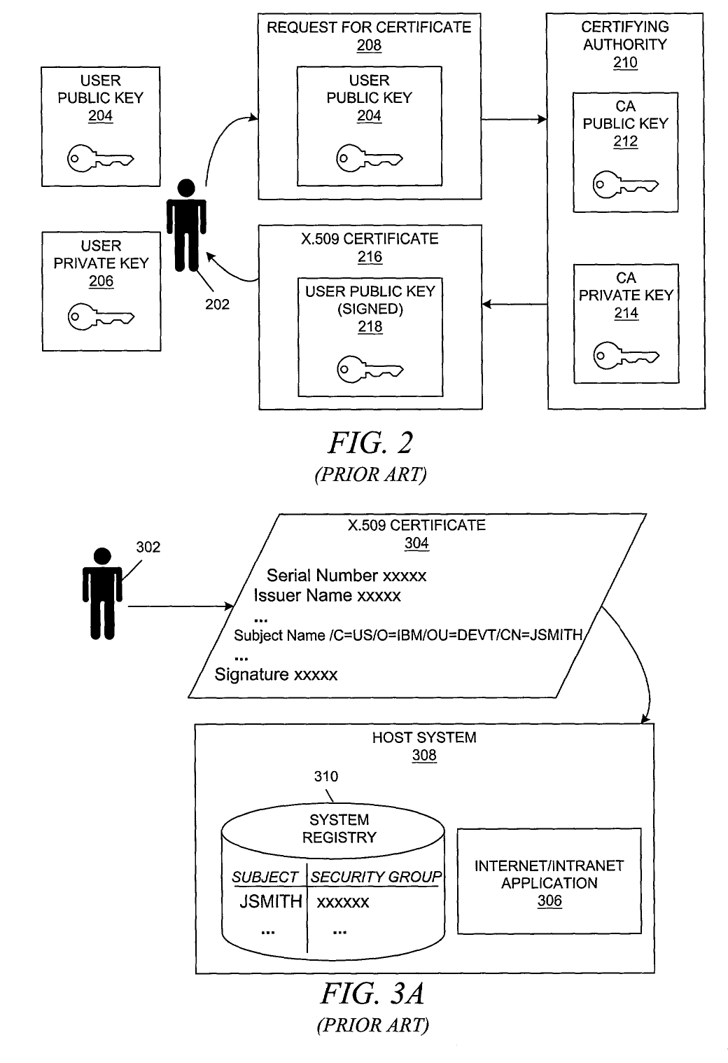

With reference now to FIG. 2, a block diagram depicts a typical manner in which an individual obtains a digital certificate. User 202, operating on some type of client computer, has previously obtained or generated a public/private key pair, e.g., user public key 204 and user private key 206. User 202 generates a request for certificate 208 containing user public key 204 and sends the request to certifying authority 210, which is in possession of CA public key 212 and CA private key 214. Certifying authority 210 verifies the identity of user 202 in some manner and generates X.509 digital certificate 216 containing signed user public key 218 that was signed with CA private key 214. User 202 receives newly generated digital certificate 216, and user 202 may then publish digital certificate 216 as necessary to engage in trusted transactions or trusted communications. An entity that receives digital certificate 216 may verify the signature of the CA by using CA public key 212, which is published and available to the verifying entity.

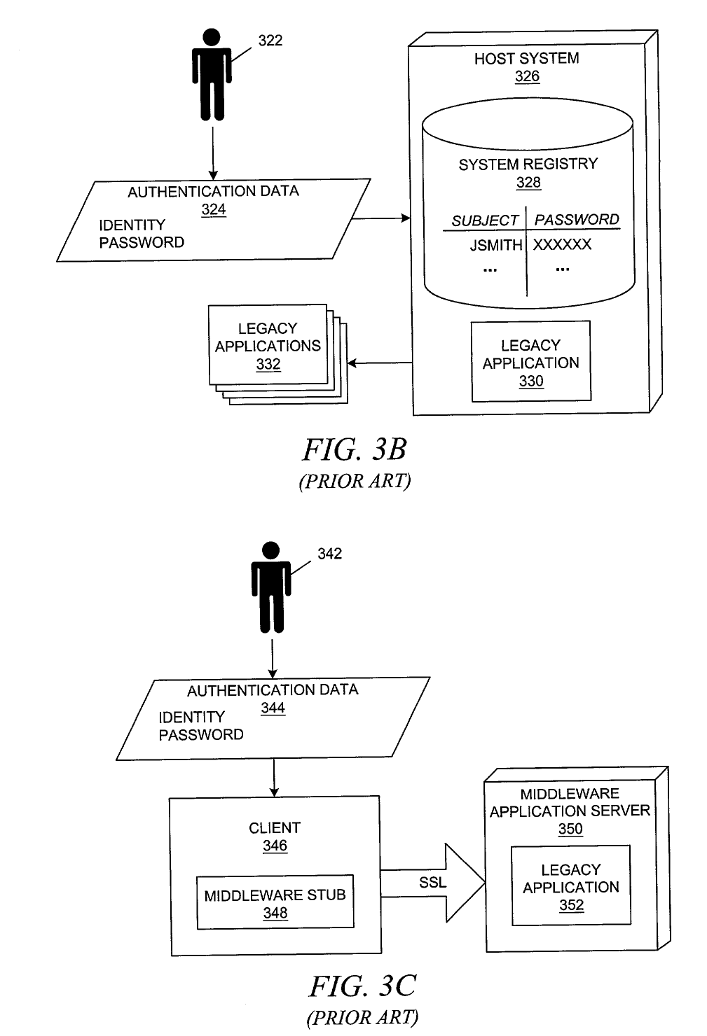

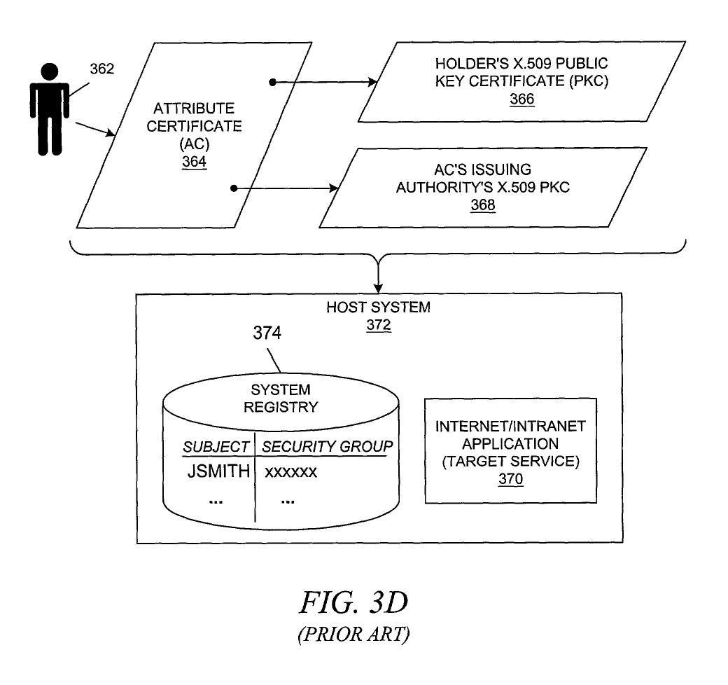

With reference now to FIG. 3A, a block diagram depicts a typical manner in which an entity may use a digital certificate to be authenticated to an Internet system or application. User 302 possesses X.509 digital certificate 304, which is transmitted to an Internet or intranet application 306 that comprises X.509 functionality for processing and using digital certificates and that operates on host system 308. The entity that receives certificate 304 may be an application, a system, a subsystem, etc. Certificate 304 contains a subject name or subject identifier that identifies user 302 to application 306, which may perform some type of service for user 302.

Host system 308 may also contain system registry 310 which is used to authorize user 302 for accessing services and resources within system 308, i.e. to reconcile a user's identity with user privileges. For example, a system administrator may have configured a user's identity to belong to certain a security group, and the user is restricted to being able to access only those resources that are configured to be available to the security group as a whole. Various well-known methods for imposing an authorization scheme may be employed within the system.

With reference now to FIG. 3B, a block diagram depicts a typical manner in which an entity may use authentication data to be authenticated to a legacy system or application. User 322 may engage in an authentication process from a client machine to other systems by sending authentication data 324 comprising identity information and some type of secret information, such as a password. Host system 326 receives authentication data 324, which can be reconciled with identity information in system registry 328, and host system 326 may then allow user 322 to use its services and resources, such as legacy application 330. User 322 may have multiple identities on host system 326 for authenticating to multiple systems or applications, such as legacy applications 332 that may reside on other servers connected to host system 326. User 322 may also have other identities on other host systems, which would require multiple sets of authentication data similar to authentication data 324.

FIGS. 3A-3B show a problem that can arise when a user has multiple identities within an enterprise—the multiple identities may be decoupled, thereby forcing the systems within the enterprise to perform different methods of authentication. The subject name within a user's certificate is possibly unknown to many applications running on host systems, particularly legacy applications, yet the certificate holder may have an associated identity on the host systems. Because the identities are decoupled, a host application server may be prevented from taking advantage of the reliable authentication methodology that an X.509 certificate provides at lower level authentication protocols, such as a Secure Socket Layer (SSL) stack.

To remedy this problem, many systems employ a middleware solution. Middleware application servers enable clients that are using new programming environments, such as HTTP and CORBA (Common Object Request Broker Architecture), to have access to legacy applications, which may have been in existence long before the deployment of the middleware. The legacy applications still require user authentication via the typical means of providing a user identity and a password in plain-text form while the middleware layer may be using a different authentication mechanism. Most of these solutions use the Secure Socket Layer (SSL) protocol to provide a secure cryptographic channel through which a password is passed on to the legacy application.

With reference now to FIG. 3C, a block diagram depicts a typical manner in which an entity may use authentication data to be authenticated to a legacy system or application through a middleware layer. User 342 may engage in an authentication process with legacy systems and applications by supplying authentication data 344 comprising identity information and some type of secret information, such as a password, to client machine 346. Middleware stub 348 transmits authentication data to middleware application server 350 via the SSL protocol. Middleware application server 350 receives and decrypts authentication data 344 and then passes the authentication data to legacy application 352. After user 342 has been authenticated by legacy application 352, middleware application server 350 and middleware stub 348 support the transfer of data between client 346 and legacy application 352.

The use of SSL sessions are costly in terms of performance. Furthermore, the cryptographic protection is socket-to-socket only; a password is available in its plain-text form within the middleware application server's runtime environment immediately after the authentication data is decrypted, thereby introducing some vulnerability into the security mechanism. Hence, various other digital certificates have been proposed such that digital certificates can be used in a variety of authentication and authorization environments.

In order to facilitate the separation of authentication functions and authorization functions, a standard for an X.509 Attribute Certificate (AC) has been proposed by which attribute certificates (ACs) would be similar in structure to public key certificates (PKCs) but in which the attribute certificate would not contain a public key. An attribute certificate would be used to certify or otherwise securely bind a set of authorization capabilities to its subject holder. Those capabilities are possibly authenticated and then cryptographically verified by a target service sought by the holder of the attribute certificate, and the attribute certificate may then be used for enabling access to controlled resources.

A common analogy using passports and visas has been widely disseminated to explain the differences between public key certificates and attribute certificates. A public key certificate can be analogized to a passport: each identify the holder of the document; each have relatively long validity periods; and each require significant effort to obtain a valid document.

In contrast, an attribute certificate can be analogized to a visa. A visa is used to gain access somewhere in a manner similar to using an attribute certificate to gain access to a system. In addition, a visa must be accompanied by a passport that verifies/authenticates the identity of the holder of the passport and the visa. Similarly, an attribute certificate must be accompanied by a public key certificate to verify/authenticate the identity of the user. A visa is issued by an authority other than the authority that issues a passport, which is similar to an attribute certificate being issued by an authority different from the authority that issues the public key certificate. A visa and an attribute certificate have shorter validity periods than a passport or a public key certificate.

Public key certificates can provide an identity for controlled access purposes. However, merely proving one's identity does not provide one with access to a controlled resource. Instead, a role or group-membership is used; if the user can prove one's identity and that the identity has been previously associated with a role or a group membership, then one may gain access to a controlled resource.

Although it is possible to do so, placing authorization information in a public key extension can be problematic. For example, a user may have a valid identity for a relatively long period of time, but the user's authorized access privileges may change over time with each authorization period being shorter than the valid period of time for the user's identity. If one were to place the authorization information in a public key extension, then the public key certificate would have to be reissued when the user's privileges change, which would cause a significant administrative burden.

In other words, the concept of an X.509 Attribute Certificate, to which an X.509 V3 Public Key Certificate is a fundamental aspect, seeks to certify or securely bind a set of authorization capabilities to a subject in the same manner that an X.509 public key certificate binds a public key to that subject. The rationale behind the distinction between these two types of certificates is dictated by the dynamic nature of authorization roles that a particular entity can assume over a period of time while in possession of the same public key certificate.

Another problem, as was noted above, is that the authority that issues the public key certificate to verify the identity of a person is usually not the same authority that desires to authorize that person for use of particular systems. In fact, a preferred scheme would have relatively few public key certifying authorities on which many other institutions rely while these other institutions determine the authorization parameters for each individual institution. If the authorization information is placed into a public key extension, then the public key certifying authority must obtain authorization information from each institution to which the user desires to present the public key certificate, which is very difficult administratively.

Hence, it has been recognized that the public key infrastructure would be better served by separating authorization information from authentication information. However, authorization information must still be bound to a holder's identity to be useful.

In order to facilitate such a scheme, an attribute certificate provides a binding between a certificate holder and a set of attributes; the attribute certificate is a digitally signed (or certified) identity and set of attributes. After acquiring an attribute certificate, a user may present the attribute certificate in an attempt to gain access to a controlled resource. When a decision must be made concerning whether a user should have access to the controlled resource, the deciding authority needs to verify the identity of the holder of the attribute certificate.

Hence, an attribute certificate is generally presented along with a public key certificate to access various security services, access controlled services, authentication services, etc. The attribute certificate contains some type of information that links the attribute certificate with a public key certificate, and the public key certificate is used for authentication purposes in conjunction with a request to access the controlled resource.

With reference now to FIG. 3D, a block diagram depicts a typical manner in which an entity may use an attribute certificate and its associated public key certificates to be authenticated and authorized to an Internet system or application in order to be granted access to controlled resources. User 362 possesses X.509 attribute certificate 364. User 362 sends attribute certificate 364, along with the user's associated PKC 366 and PKC 368 of the issuing authority for the user's attribute certificate, to Internet/intranet application (target service) 370 that comprises X.509 functionality and that operates on host system 372. As noted previously, an attribute certificate may contain attributes that specify group membership, role, security clearance, or other authorization information associated with the holder of the attribute certificate. Host system 372 may also contain system registry 374 that allows user 362 to access services and resources within system 370 as specified by information within attribute certificate 364.

In summary, an X.509 attribute certificate is a document that has been cryptographically signed by an AC-issuing authority. This signing process uses the private key of the attribute certificate authority, for which there is a corresponding public key published in a public key certificate issued for the attribute-certificate-issuing authority.

An application service that contains PKIX-functionality uses the public key certificate of the user in conjunction with some predefined security protocol, such as SSL, in order to establish data origin authenticity/integrity or confidentiality during exchanges with a particular client. At some subsequent point in time, a user may attempt to access a controlled resource at a target service, and the user's access capabilities are determined from the user's attribute certificate. The user sends both his/her attribute certificate and public key certificate to the target service. The two certificates are linked together in some manner; in the X.509 specification, the “Holder” field in the attribute certificate contains linking information for the public key certificate, such as the identity of the public key certificate's issuing authority and the serial number of the holder's public key certificate.

After receiving the user's certificates, the public key certificate of the authority that issued the attribute certificate is needed in order to validate the attribute certificate that has been presented by the user. In general, the target service would be configured with information on all of the AC-issuing authorities that the target service is willing to accept or trust. The target service may accept the public key certificate of the AC-issuing authority as sent by the user, or the target service may retrieve the public key certificate of the AC-issuing authority from a public directory.

To facilitate using attribute certificates with legacy applications, the proposed specification for a X.509 Attribute Certificate includes an attribute type, “SvceAuthInfo”, for service authentication. The “SvceAuthInfo” attribute identifies the AC holder to the server/service by a name, and the attribute may include optional service specific authentication information.

While not necessary, this attribute type would typically contain a user identity and password pair for a legacy application, which would usually be encrypted when the “authInfo” field of the “SvceAuthInfo” attribute type contains sensitive information, such as a password. In general, this attribute type provides information that can be presented by the AC holder to be interpreted and authenticated by a separate application within the target system.

While it has been contemplated in the prior art that the “SvceAuthInfo” attribute type within a given attribute certificate would be encrypted to protect any sensitive information, the present invention provides a novel method by which an attribute certificate can contain password-based authentication information for one or more target legacy applications without compromising the authentication information at any point outside of a particular target legacy application. Moreover, the present invention can be used to present password-based authentication information to a target legacy application server that supports multiple target legacy applications without requiring the use of SSL sessions. While the present invention may employ a variety of digital certificates, the preferred embodiment of the present invention employs digital certificates that are compliant with the X.509 family of standards.

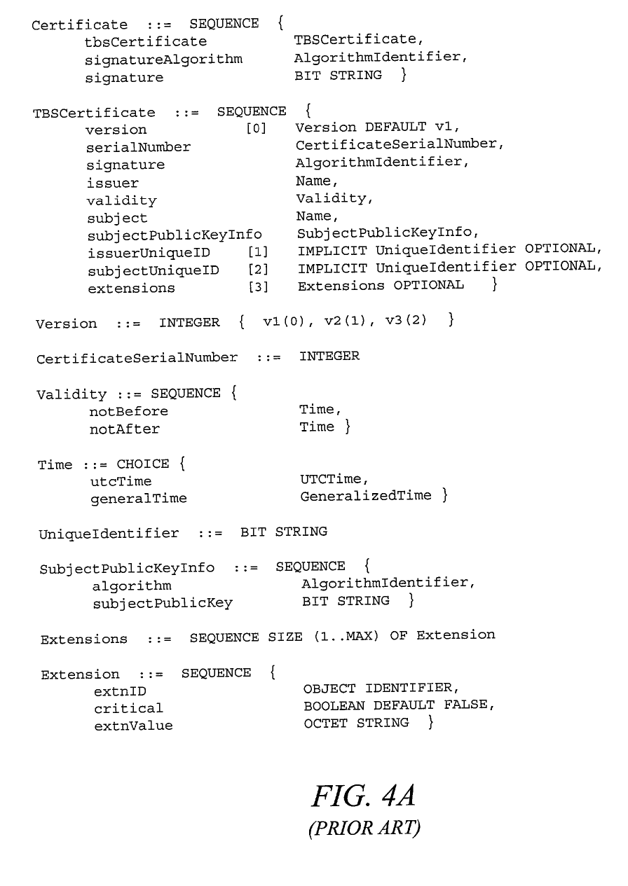

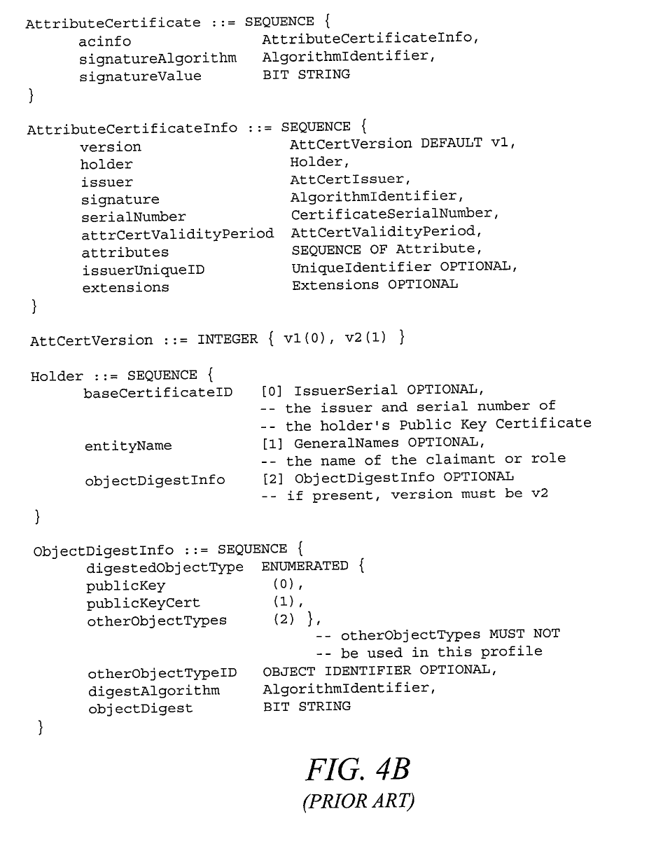

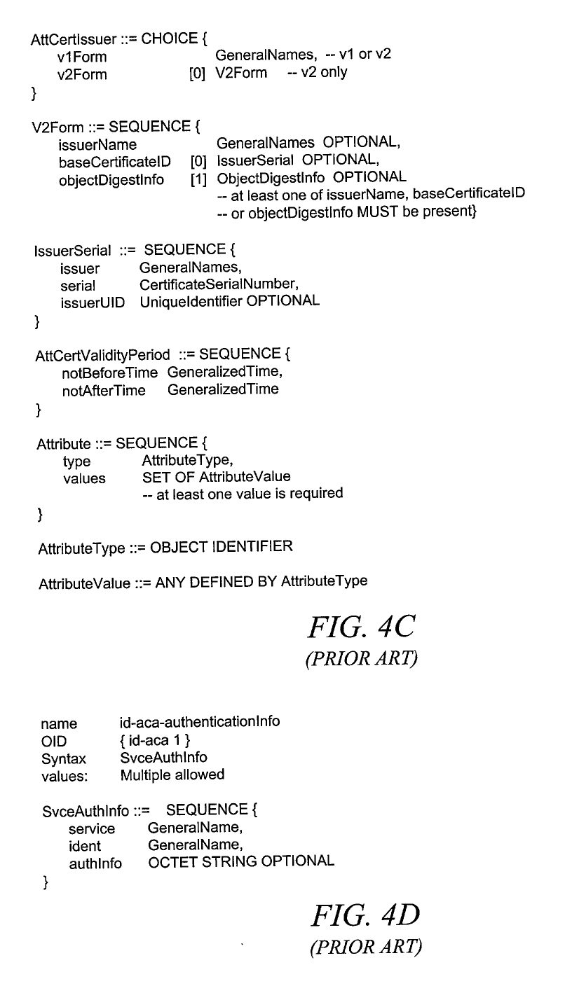

With reference now to FIG. 4A, some of the fields of a standard X.509 digital certificate are shown. The constructs shown in FIG. 4A are in Abstract Syntax Notation 1 (ASN.1) and are defined within the X.509 standard.

With reference now to FIGS. 4B-4D, some of the fields of an X.509 attribute certificate are shown. The constructs shown in FIGS. 4B-4D are also in ASN.1 notation.

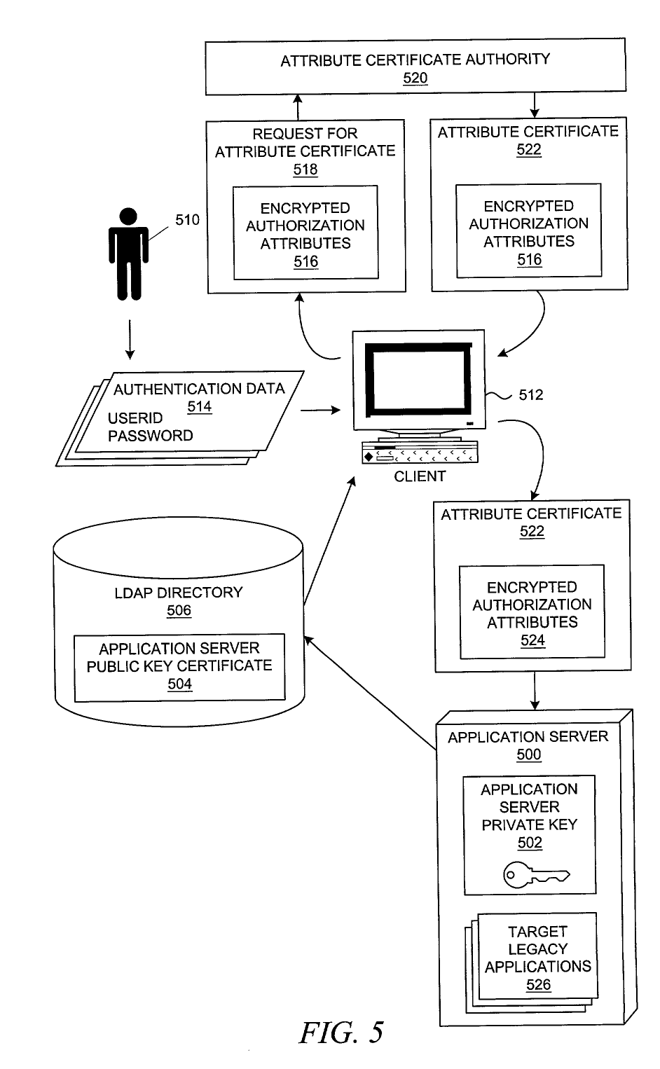

With reference now to FIG. 5, a diagram depicts a process for requesting an X.509 attribute certificate containing encrypted authorization attributes and also a process for using the X.509 attribute certificate that will access a target legacy application in accordance with a preferred embodiment of the present invention.

In the present invention, the attribute certificate contains one or more sets of authorization attributes for controlled resources, such as legacy applications, supported by a host system, an application server, a target service, or the like. In the preferred embodiment, the one or more sets of authorization attributes are inserted into a standard “SvceAuthInfo” field of an X.509 attribute certificate, as shown in FIG. 4D using ASN.1 notation.

It should be noted that the encrypted authorization attributes are not limited to being incorporated only within the X.509 standard and that the X.509 standard is merely one set of definitions of digital certificates into which the encrypted authorization attributes of the present invention could be incorporated; the present invention may also use other digital certificate standards or formats other than X.509 as long as the digital certificates can convey the required information. Additionally, it should be noted that the format of the encrypted authorization attributes could vary from the format shown in FIG. 4D.

At some point in time, a public/private key pair has been generated for application server 500, which safeguards its application server private key 502 while publishing its public key within application server public key certificate 504 in LDAP directory 506 (Lightweight Directory Access Protocol) for general public use.

Subsequently, user 510 operates an application, such as a certificate management application, on client 512 to obtain an attribute certificate that may be used with application server 500. User 510 provides one or more sets of authentication data 514, each of which comprise a user identity and a password (or some other type of secret authentication token or data) or other additional information. For example, each set of authentication data may be used to access a legacy application, such as a legacy database application at a remote location like application server 500. Application server public key certificate 504 is retrieved to encrypt one or more sets of authentication data 514 with the public key of application server 500, thereby generating encrypted authorization attributes 516. The encrypted authorization information is then placed into request 518 for requesting an attribute certificate, along with identifying information for application server 500, and sent to attribute certificate authority 520. In the preferred embodiment, the encrypted authorization information has been generated with an appropriate format so that attribute certificate authority 520 can copy it into an attribute certificate.

An attribute certificate may be used with more than one server or service. For each service or application server that is being associated with the attribute certificate, identifying information for each service or server would also be sent in the request. Assuming that an X.509 attribute certificate is being used, the attribute certificate authority then places the identifying information into the “service” field of the “SvceAuthInfo” attribute of the attribute certificate; at a later time, each server, service, or host may retrieve its information within the attribute certificate by locating its appropriate “service” field. The identifying information for a service or server may be a host name that provides many services, a URL (Uniform Resource Locator) or URI (Uniform Resource Identifier), a qualified Web address, an IP address of an enterprise's server, etc.

In response to receiving the request, the attribute certificate authority generates and signs attribute certificate 522 that contains encrypted authorization attributes 516. Other fields of attribute certificate 522 would be filled with any appropriate or necessary data. Attribute certificate authority 520 then sends attribute certificate 522 to client 512, which stores the attribute certificate for later use.

Assuming that an X.509 attribute certificate is being used, the “ident” field of the “SvceAuthInfo” attribute type contains a user identifier for the authentication information, while the “authInfo” field of the “SvceAuthInfo” attribute type contains the secret or confidential authenticating data, such as a password. A portion of the field may be viewed as consisting of a password appended to its user identifier, which is then appended to the corresponding application, server, service, or host name, with each separated by a delimiting character. If the “SvceAuthInfo” field contains only one set of authentication parameters or information, the entire field may consist of a string such as “applname\userID\password”. If the “SvceAuthInfo” field contains more than one set of authentication parameters or information because the service or server supports more than one legacy application, a sufficient string may be “applname\userID\password\\applname\userID\password . . .”. In other words, multiple sets may be appended to each other while being separated by an appropriate delimiting character or characters. It should be noted that the format of the entire “SvceAuthInfo” field may vary depending upon the implementation of the present invention.

At some later time, user 510 desires to interact with one or more legacy applications 526 on application server 500. Using an appropriate protocol, application server 500 requests and/or receives a copy of attribute certificate 522 containing encrypted authentication attributes 524. Application server 500 locates the appropriate “SvceAuthInfo” attribute within attribute certificate 522 using the “service” field and extracts its associated “authInfo” data.

At this point, the “authInfo” data comprises an encrypted string of one or more sets of user identities, passwords, and possibly other optional data. Application server 500 then uses its private key 502 to decrypt the “authInfo” data and extract the portion of the “authInfo” data that is required by each legacy application in which the client's transaction is occurring. The appropriate set of authentication data is then forwarded to each legacy application 526 as necessary.

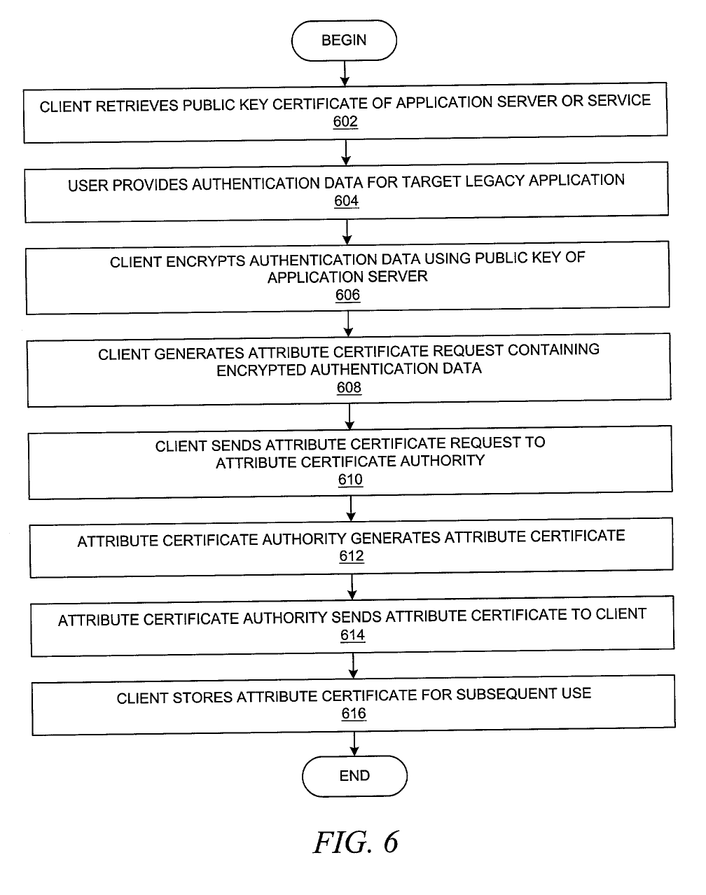

With reference now to FIG. 6, a flowchart depicts a process for obtaining an attribute certificate that will authenticate a certificate holder to a target legacy application in accordance with a preferred embodiment of the present invention. The process shown in FIG. 6 is similar to a portion of the processing that was described with respect to FIG. 5.

The processing begins in FIG. 6 with a user at a client system who desires to obtain an attribute certificate that will provide access to a target legacy application. Preferably, the user operates an application on the client that performs the following steps on behalf of the user after gathering information from the user concerning the target legacy application, the user's authentication data for the target legacy application, etc.

As a first step, the client retrieves the public key certificate of the application server or service that supports the target legacy application (step 602). It should be noted that the type of entity associated with the public key certificate may vary from system to system or from service to service. In other words, the type of entity that performs certificate processing at the server on behalf of the legacy application may vary. At some point, however, an application on a target server that is enabled for processing digital certificates will receive the attribute certificate and process the authentication data within the attribute certificate on behalf of the legacy application.

The user at the client then provides the authentication data required by the target legacy application (step 604). Alternatively, the client application may retrieve the required information from a secured datastore associated with the user. The client then encrypts the authentication data using the public key of the application server that was retrieved from its public key certificate (step 606). The client generates an attribute certificate request containing the encrypted authentication data (step 608) and sends the attribute certificate request to an attribute certificate authority (step 610). Communication between the client and the attribute certificate authority may occur through some type of secure communication channel.

In response, the attribute certificate authority generates an attribute certificate containing the encrypted authentication data and signs the attribute certificate with the attribute certificate authority's private key as proof of the attribute certificate's authenticity (step 612). The attribute certificate authority then sends the attribute certificate to the client (step 614), and the client stores the attribute certificate for subsequent use (step 616). The process of acquiring an attribute certificate according to the present invention is then complete.

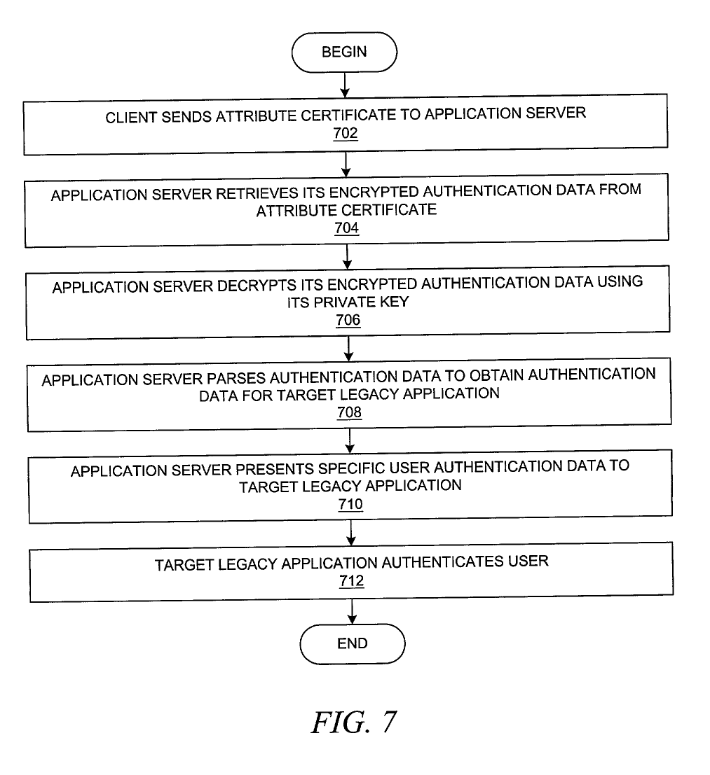

With reference now to FIG. 7, a flowchart depicts a process for using an attribute certificate that will authenticate a certificate holder to a target legacy application in accordance with a preferred embodiment of the present invention. The process shown in FIG. 7 is similar to a portion of the processing that was described with respect to FIG. 5.

The processing begins in FIG. 7 with a user at a client system who desires to use target legacy application. Preferably, the user operates an application on the client that performs the following steps on behalf of the user.

The client sends the attribute certificate to an application service or server that is supporting the target legacy application (step 702). The communication between the client and the application server may occur using an appropriate protocol and may include additional transfers of information concerning the transaction that the client is attempting to complete with the application server. It is should be noted that the communication between the client and the application server does not require a cryptographically enhanced communication channel as the one or more passwords within the attribute certificate have been previously encrypted.

The application server then retrieves its encrypted authentication data from the attribute certificate (step 704); the attribute certificate may contain authentication data for multiple application services or servers. The application server then uses its private key to decrypt the encrypted authentication data (step 706), and the application server parses the decrypted authentication data to obtain the authentication data for the specific target legacy application or applications that are being used for the client's transaction (step 708). The application server then presents the specific user authentication data, such as a user identity and password, to the target legacy application (step 710). Assuming that the target legacy application successfully authenticates the user, the target legacy application then allows the client to perform additional processing (step 712). The process of using the attribute certificate according to the present invention is then complete.

It should be noted that many other common steps, such as verifying the authenticity of a public key certificate, have not been described with respect to FIG. 6 and FIG. 7. As another example, the attribute certificate authority may verify the identity of the user prior to issuing the attribute certificate, or the application server may verify the authenticity of the user's attribute certificate with the attribute certificate authority. One of ordinary skill in the art would recognize that other processing steps that are common to the processing of digital certificates may be involved and have been omitted for simplicity of presentation.

The advantages of the present invention should be apparent in view of the detailed description of the invention that is provided above. By using a novel manner of storing authentication data within an attribute certificate, the present invention allows an attribute certificate to be used with a legacy application.

Prior art solutions have required cryptographic communication channels between the client and the application server, typically via a middleware layer. These types of solutions are computationally much more expensive than a plain-text communication session through which the present invention can be accomplished; the present invention securely passes a password credential to a remote legacy application without using an encrypted communication session, such as SSL.

Besides providing a secure method of passing a password to a remote legacy application without requiring the setup of a cryptographic channel, the methodology of the present invention allows the security-sensitive password to reside in the runtime of the application server in its encrypted form until it is needed for accessing the one or more legacy applications supported by the application server. In addition, the present invention does not contribute any additional complexity to the usage model and certificate validation process of PKIX than the prior art methodologies for using attribute certificates.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for an authentication process within a distributed data processing system, the method comprising:
receiving an attribute certificate from a client at a host within the distributed data processing system;
extracting encrypted authentication data from the attribute certificate, wherein the encrypted authentication data was generated by encrypting authentication data with a public key associated with the host;
decrypting the encrypted authentication data to regenerate the authentication data using a private key associated with the host; and
forwarding the authentication data to a controlled resource.

2. The method of claim 1 wherein the controlled resource is a legacy application.

3. The method of claim 1 wherein the authentication data comprises a user identity and a password.

4. The method of claim 1 further comprising:
authenticating the client for access to the controlled resource based on the authentication data.

5. The method of claim 1, wherein the attribute certificate contains multiple sets of authentication data for multiple hosts, the method further comprising:
parsing the authentication data to retrieve a specific set of authentication data for the host.

6. The method of claim 1 wherein the authentication data contains multiple sets of authentication parameters for multiple controlled resources, the method further comprising:
parsing the authentication data to retrieve a specific set of authentication data for the controlled resource.

7. The method of claim 1 wherein the attribute certificate and the public key certificate are formatted according to an X.509 standard.

8. A method for generating a digital certificate, the method comprising:
receiving, at an attribute-certificate-issuing authority, a request for an attribute certificate from a client;
generating the attribute certificate in response to the received request for an attribute certificate, wherein the attribute certificate comprises encrypted authentication data that was generated by encrypting authentication data for a controlled resource at a host with a public key associated with the host; and
sending the generated attribute certificate to the client.

9. The method of claim 8 wherein the controlled resource is a legacy application.

10. A method for obtaining a digital certificate, the method comprising:
retrieving a public key certificate associated with a host within a distributed data processing system;
extracting a public key associated with the host from the public key certificate;
encrypting with the public key authentication data for a controlled resource at the host;
generating a request for an attribute certificate;
storing the encrypted authentication data within the request for the attribute certificate;
sending the request for the attribute certificate to an attribute-certificate-issuing authority; and
receiving an attribute certificate from the attribute-certificate-issuing authority, wherein the attribute certificate comprises the encrypted authentication data.

11. The method of claim 10 wherein the controlled resource is a legacy application.

12. A data structure representing an attribute certificate for use in a data processing system, the data structure comprising:
an issuer name;
a signature;
a holder name;
an attribute containing encrypted authentication data that was generated by encrypting authentication data for a controlled resource at a host with a public key associated with the host.

13. The data structure of claim 12 wherein the controlled resource is a legacy application.

14. An apparatus for performing an authentication process within a distributed data processing system, the apparatus comprising:
receiving means for receiving an attribute certificate from a client at a host within the distributed data processing system;
extracting means for extracting encrypted authentication data from the attribute certificate, wherein the encrypted authentication data was generated by encrypting authentication data with a public key associated with the host;
decrypting means for decrypting the encrypted authentication data to regenerate the authentication data using a private key associated with the host; and
forwarding means for forwarding the authentication data to a controlled resource.

15. The apparatus of claim 14 wherein the controlled resource is a legacy application.

16. The apparatus of claim 14 wherein the authentication data comprises a user identity and a password.

17. The apparatus of claim 14 further comprising:
authenticating means for authenticating the client for access to the controlled resource based on the authentication data.

18. The apparatus of claim 14, wherein the attribute certificate contains multiple sets of authentication data for multiple hosts, the apparatus further comprising:
first parsing means for parsing the authentication data to retrieve a specific set of authentication data for the host.

19. The apparatus of claim 14 wherein the authentication data contains multiple sets of authentication parameters for multiple controlled resources, the apparatus further comprising:
second parsing means for parsing the authentication data to retrieve a specific set of authentication data for the controlled resource.

20. The apparatus of claim 14 wherein the attribute certificate and the public key certificate are formatted according to an X.509 standard.

21. An apparatus for generating a digital certificate, the apparatus comprising:
receiving means for receiving, at an attribute-certificate-issuing authority, a request for an attribute certificate from a client;
generating means for generating the attribute certificate in response to the received request for an attribute certificate, wherein the attribute certificate comprises encrypted authentication data that was generated by encrypting authentication data for a controlled resource at a host with a public key associated with the host; and
sending means for sending the generated attribute certificate to the client.

22. The apparatus of claim 21 wherein the controlled resource is a legacy application.

23. An apparatus for obtaining a digital certificate, the apparatus comprising:
retrieving means for retrieving a public key certificate associated with a host within a distributed data processing system;
extracting means for extracting a public key associated with the host from the public key certificate;
encrypting means for encrypting with the public key authentication data for a controlled resource at the host;
generating means for generating a request for an attribute certificate;
storing means for storing the encrypted authentication data within the request for the attribute certificate;
sending means for sending the request for the attribute certificate to an attribute-certificate-issuing authority; and
receiving means for receiving an attribute certificate from the attribute-certificate-issuing authority, wherein the attribute certificate comprises the encrypted authentication data.

24. The apparatus of claim 23 wherein the controlled resource is a legacy application.

25. A computer program product in a computer readable medium for use in a distributed data processing system for performing an authentication process, the computer program product comprising:
instructions for receiving an attribute certificate from a client at a host within the distributed data processing system;
instructions for extracting encrypted authentication data from the attribute certificate, wherein the encrypted authentication data was generated by encrypting authentication data with a public key associated with the host;
instructions for decrypting the encrypted authentication data to regenerate the authentication data using a private key associated with the host; and
instructions for forwarding the authentication data to a controlled resource.

26. The computer program product of claim 25 wherein the controlled resource is a legacy application.

27. The computer program product of claim 25 wherein the authentication data comprises a user identity and a password.

28. The computer program product of claim 25 further comprising:
instructions for authenticating the client for access to the controlled resource based on the authentication data.

29. The computer program product of claim 25, wherein the attribute certificate contains multiple sets of authentication data for multiple hosts, the computer program product further comprising:
instructions for parsing the authentication data to retrieve a specific set of authentication data for the host.

30. The computer program product of claim 25 wherein the authentication data contains multiple sets of authentication parameters for multiple controlled resources, the computer program product further comprising:
instructions for parsing the authentication data to retrieve a specific set of authentication data for the controlled resource.

31. The computer program product of claim 25 wherein the attribute certificate and the public key certificate are formatted according to an X.509 standard.

32. A computer program product in a computer readable medium for use in a data processing system for generating a digital certificate, the computer program product comprising:
instructions for receiving, at an attribute-certificate-issuing authority, a request for an attribute certificate from a client;
instructions for generating the attribute certificate in response to the received request for an attribute certificate, wherein the attribute certificate comprises encrypted authentication data that was generated by encrypting authentication data for a controlled resource at a host with a public key associated with the host; and
instructions for sending the generated attribute certificate to the client.

33. The computer program product of claim 32 wherein the controlled resource is a legacy application.

34. A computer program product in a computer readable medium for use in a data processing system for obtaining a digital certificate, the computer program product comprising:
instructions for retrieving a public key certificate associated with a host within a distributed data processing system;
instructions for extracting a public key associated with the host from the public key certificate;
instructions for encrypting with the public key authentication data for a controlled resource at the host;
instructions for generating a request for an attribute certificate;
instructions for storing the encrypted authentication data within the request for the attribute certificate;
instructions for sending the request for the attribute certificate to an attribute-certificate-issuing authority; and
instructions for receiving an attribute certificate from the attribute-certificate-issuing authority, wherein the attribute certificate comprises the encrypted authentication data.

35. The computer program product of claim 34 wherein the controlled resource is a legacy application.
